(19) United States
(12) Patent Application Publication
(10) Pub. No.: US 2014/0214901 A1
(43) Pub. Date: Jul. 31, 2014

(54) VIRTUAL STORAGE SYSTEM AND FILE STORING METHOD

(71) Applicant: DIGITALMAILER, INC., Herndon, VA (US)

(72) Inventors: Ronald M. Daly, JR., Centreville, VA (US); Leonard Giambalvo, Fort Mill, SC (US); Robert Jacob Smilie, Concord, NC (US)

(73) Assignee: DIGITALMAILER, INC., Herndon, VA (US)

(21) Appl. No.: 13/752,043

(22) Filed: Jan. 28, 2013

(51) Int. Cl. G06F 17/30

(52) U.S. Cl. CPC G06F 17/30115
USPC 707/803

(57) ABSTRACT

A virtual storage system in data communication with a user computing device via a communication network and a file storing for storing electronic documents within a virtual storage system where the virtual storage system includes at least one processor that receives a selection of an electronic document to be uploaded from an external system, creates an identifier corresponding to the electronic document, and creates a folder structure using the identifier, for storing the electronic document. The virtual storage system further includes a plurality of redundant physical storage devices in data communication with the at least one processor and each configured to store the electronic document within a folder of the folder structure created.

### CROSS-REFERENCE TO RELATED APPLICATIONS

The present application relates to co-pending application entitled “Virtual Storage System and Method of Copying Electronic Documents into the Virtual Storage System” by Ronald M. Daly, Jr. et al. filed on Jan. 28, 2013; co-pending application entitled “Virtual Storage System and Method of Sharing Electronic Documents within the Virtual Storage System” by Ronald M. Daly, Jr. et al. filed on Jan. 28, 2013; and co-pending application entitled “Virtual Storage System and File Encryption Methods” by Ronald M. Daly, Jr. et al. filed on Jan. 28, 2013, the entire disclosures of which are incorporated herein by reference.

### BACKGROUND OF THE INVENTION

1. Field of the Invention

The present invention relates to a virtual storage system. More particularly, the present invention relates to a virtual storage system and a file storing method implemented by the virtual storage system.

2. Description of the Related Art

Virtual storage systems have become a popular alternative for storing files, thereby eliminating the need to install physical storage devices and minimizing file storage costs. A virtual storage system is an online storage system where data is stored in virtual storage pools. The pools are hosted by third parties that operate large data centers. The third parties virtualize resources in servers and present the resources as virtual storage pools for users to store files, for example. The virtual storage system is accessed through a web application programming interface (API), a gateway or a Web-based user interface (UI), for example. A typical virtual storage system (e.g., a cloud-type storage system) has several disadvantages which create security concerns. For example, the storage location of the files stored therein may be unknown to both third party hosting companies and/or users of the virtual storage system. In addition, the typical virtual storage system can be easily accessed over a communication network (e.g., the Internet) using simple single-factor authentication processes for access thereof. The typical virtual storage system does not encrypt files that are stored on their servers which makes the files easily visible to internal employees and hackers. Further, the typical virtual storage system is not Pci Compliant (PCI DSS) a proprietary information security standard for organizations that handle cardholder information for the major debit, credit, prepaid, e-purse, ATM, and POS cards. Further, once any file is stored on the virtual storage system they become property of the virtual storage system provider and are no longer user-owned; therefore the files can be used for other purposes, such as data mining without user permission.

Online banking systems provide resources to enable users to conduct banking transactions electronically from a personal computer, for example. Online banking transactions include monitoring accounts, conducting money transfers, applying for loans, submitting loan payments, etc. However, users are required to visit the bank in person, to conduct certain transactions such as depositing documents into a safe deposit box which is an individually secured container held in a bank vault, for example. The safe deposit box is used to store valuable possessions, such as jewelry, currency, marketable securities, and important documents (e.g., bank statements, wills, passports, property deeds, insurance policies, photographs and birth certificates). Bank personnel typically open the bank vault with a key and a user is required to produce an assigned key to open the safe deposit box.

Currently, online banking systems fail to allow users to store important documents electronically, and also fail to allow users to retrieve, view and share these documents electronically outside of the bank environment, when desired.

### SUMMARY OF THE INVENTION

The present invention obviates the above-mentioned disadvantages by providing a virtual storage system that implements a file storing method for securely storing electronic documents retrieved from an external system (e.g., an online banking system), to thereby enable a user to store important documents in a known storage location within the virtual storage system.

The present invention relates to virtual storage system and a file storing method implemented by the virtual storage system.

Further, the virtual storage system of the present invention employs a multi-factor authentication process for verifying user access rights, via a specifically-designed application programming interface (API), for example, that can be installed at a user computing device, thereby providing a maximum security level of file storage for the user.

The virtual storage system of the present invention is also PCI Compliant following a proprietary information security standard to allow storage of cardholder information for the major debit, credit, prepaid, e-purse, ATM, and POS cards.

In addition, the virtual storage system locks each file with encryption as it is uploaded or copied, and only the user-owner holds the key (i.e., access rights) to retrieve the file, thereby leaving ownership of the file with the user-owner at all times and providing extra security protection from unauthorized individuals.

The present invention is a virtual storage system in data communication with a user computing device via a communication network. The virtual storage system comprises at least one processor configured to receive a selection of an electronic document to be uploaded from an external system, create an identifier corresponding to the electronic document, and create a folder structure using the identifier, for storing the electronic document; and a plurality of redundant physical storage devices in data communication with the at least one processor and each configured to store the electronic document within a folder of the folder structure created.

Further, the present invention is a method implemented by computer system to effect the storing of electronic documents within a virtual storage system including a plurality of redundant physical storage devices and in data communication via a communication network, with an external system. The method comprises receiving input data for accessing the virtual storage system directly or indirectly via the external system; selecting via a user, an electronic document to be uploaded from the external system; creating an identifier corresponding to the electronic document; and creating a folder structure using the identifier, for storing the electronic document; and storing the electronic document within a folder of the folder structure created within the plurality of redundant physical storage devices.

Further, the present invention is a computer readable medium storing computer executable instructions that, when executed, cause a computing device to perform a file storing method for storing electronic documents within a virtual storage system including a plurality of redundant physical storage devices and in data communication via a communication network, with an external system. The method comprises receiving input data for accessing the virtual storage system directly or indirectly via the external system; selecting via a user, an electronic document to be uploaded from the external system; creating an identifier corresponding to the electronic document; creating a folder structure using the identifier, for storing the electronic document; and storing the electronic document within a folder of the folder structure created within the plurality of redundant physical storage devices.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 is a block diagram of a virtual storage system that can be implemented within one or more embodiments of the present invention.

FIG. 2 is a block diagram of a virtual storage system that can be implemented within alternative embodiments of the present invention.

FIG. 3 is a block diagram of a virtual storage system that can be implemented within alternative embodiments of the present invention.

FIG. 4 is a block diagram of a virtual storage system that can be implemented within alternative embodiments of the present invention.

FIG. 5 is a block diagram of an exemplary computer to be implemented within one or more embodiments of the present invention.

FIG. 6 is a flowchart illustrating a file storing method implemented by the virtual storage system according to one or more embodiments of the present invention.

FIG. 7 is a flowchart illustrating a folder structure creating operation of the method of FIG. 6 implemented according to alternative embodiments of the present invention.

FIG. 8 is a block diagram of an exemplary physical storage system for implementation of the virtual storage system in accordance with one or more embodiments of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Specific details are given in the following description to provide a thorough understanding of the embodiments. However, it will be understood by one of ordinary skill in the art that the embodiments may be practiced without these specific details. For example, systems, networks, processes, and other components may be shown as components in block diagram form in order not to obscure the embodiments in unnecessary detail. Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The present invention as will be described in greater detail below provides a method for copying electronic documents, (e.g., electronic banking statements) into a virtual storage system and system implementing the method. The present invention provides various embodiments as described below. However it should be noted that the present invention is not limited to the embodiments described herein, but could extend to other embodiments as would be known or as would become known to those skilled in the art.

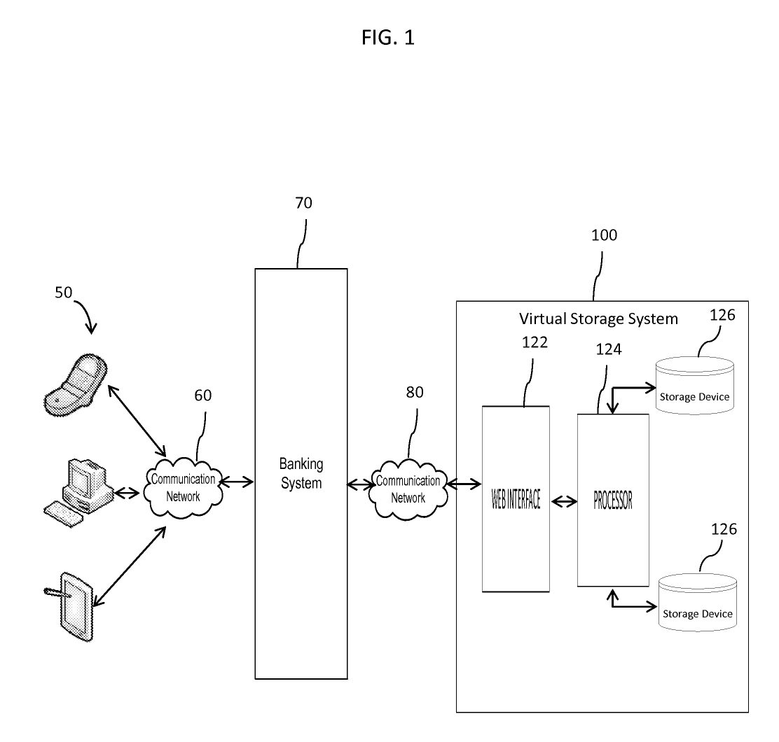

FIG. 1 is a block diagram of a virtual storage system implemented within one or more embodiments of the present invention. In FIG. 1, a user at a user computing device 50 is configured to access, via a communication network 60, an external system i.e., an online document retrieval and storage system such as a banking system 70 to perform online banking transactions, such as viewing bank accounts and bank statements, applying for loans, and other transactions. According to one or more embodiments, the user computing device 50 includes at least one of a mobile phone or smart phone, a personal computer or laptop, or a personal digital assistant (PDA) or tablet. The present invention is not limited to any particular type of user computing device 50, and may vary accordingly.

The user accesses the banking system 70 by inputting input data including identification and log-in information such as a user ID and password via a user interface (UI) of the user computing device 50. Once the identification/log-in information is received at a banking application of the banking system 70, the banking system 70 retrieves the user's banking information and displays the banking information via a display of the user computing device 50. The banking system 70 is configured to receive the input data and provide the user with electronic documents (e.g., bank statements) in webpage format or any other format over the communication network 60. The banking system 70 communicates via a communication network 80, with a virtual storage system 100 described in detail below.

The communication networks 60 and 80 include a wired or wireless network for data communication. The data communication across the communication networks 60 and 80 is achieved by using web services technology including for example, Web services Description Language (WSDL). The communication networks 60 and 80 may include any subsystem for exchanging data such as the Internet, intranet, extranet, wide area network (WAN), local area network (LAN), Restful web services, JAVAScript Object Notation (JSON), Extensible Mark-up Language (XML)-based communication network, Simple Object Access Protocol (SOAP)-based Services and satellite communication network. Further, the communication networks 60 and 80 can be other types of networks such as interactive television (ITV). According to one or more embodiments, the communication networks 60 and 80 may be the same or different types of networks.

The virtual storage system 100 is a user-specific storage system which allows each user to have a secure access to their files stored within the virtual storage system 100. In addition, the virtual storage system 100 encrypts each electronic document as it is retrieved from the external system, and only the user-owner can access the electronic document thereby leaving ownership of the files within the virtual storage system 100 with the user-owner at all times.

According to one or more embodiments, the virtual storage system 100 includes a web interface 122 for interfacing with the external system (i.e., the banking system 70) over the communication network 80. The web interface 122 provides a secure connection to the virtual storage system 100. According to one or more embodiments, the web interface 122 is a specifically-designed application programming interface (API), for example, which performs authentication of the user or the external system (e.g., the banking system 70) at multiple levels. A secure connection is made between the banking system 70 and the virtual storage system 100 on a transport layer level, for example. According to one or more embodiments, a transport layer security (TLS) or secure sockets layer (SSL) cryptographic protocol may be employed to provide secure communication over the communication networks 60 and 80. According to one or more embodiments, the web interface 122 is a web application programming interface (API), a gateway or a Web-based user interface (UI), for example.

According to one or more embodiments, the virtual storage system 100 is PCI Compliant to allow storage of cardholder information for the major debit, credit, prepaid, e-purse, ATM, and POS cards. The virtual storage system 100 further includes at least one processor 124 for receiving information including requests from the user at the banking system 70 and processing the requests, such as storing, retrieving and copying electronic documents. The virtual storage system 100 further includes at least one storage server 125 comprising a plurality of physical storage devices 126 for storing files such as documents, audio files, photographs, movies, and images received from the user via the banking system 70. The virtual storage system 100 acts as a safe deposit box for receiving and securely storing the files received from the user via the banking system 70. Although only one processor 124 and two storage devices 126 are shown, the present invention is not limited hereto, and may vary accordingly.

As shown in FIG. 1, the virtual storage system 100 includes a web interface (e.g., the web interface 122) however the present invention is not limited to this particular configuration, and may vary accordingly.

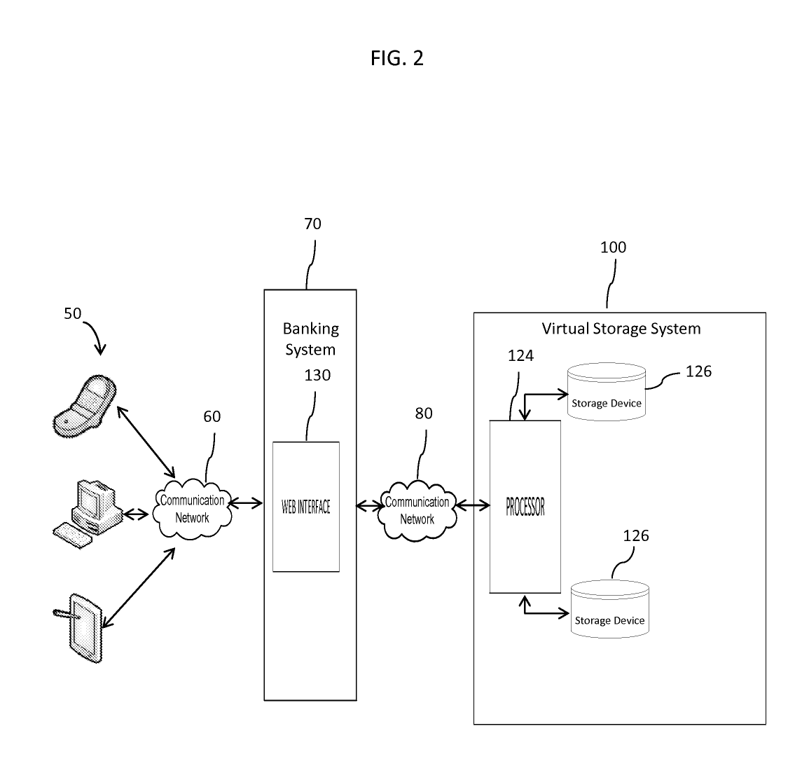

FIGS. 2 through 4 illustrate alternative configurations of the virtual storage system 100, and communication between the virtual storage system 100, the external system (e.g., the banking system 70), and/or the user computing device 50 according to other embodiments of the present invention that may be implemented. Some of the components shown in FIGS. 2 through 4 are the same as the components discussed above with reference to FIG. 1 therefore a detailed description of these components is omitted.

As shown in FIG. 2, in an alternative embodiment, the banking system 70 includes a web interface 130 configured to interface the banking system 70 with the virtual storage system 100 over the communication network 80. The web interface 130 functions in a similar manner as the web interface 122 of the virtual storage system 100 therefore in this embodiment, the web interface 122 of the virtual storage system 100 is omitted.

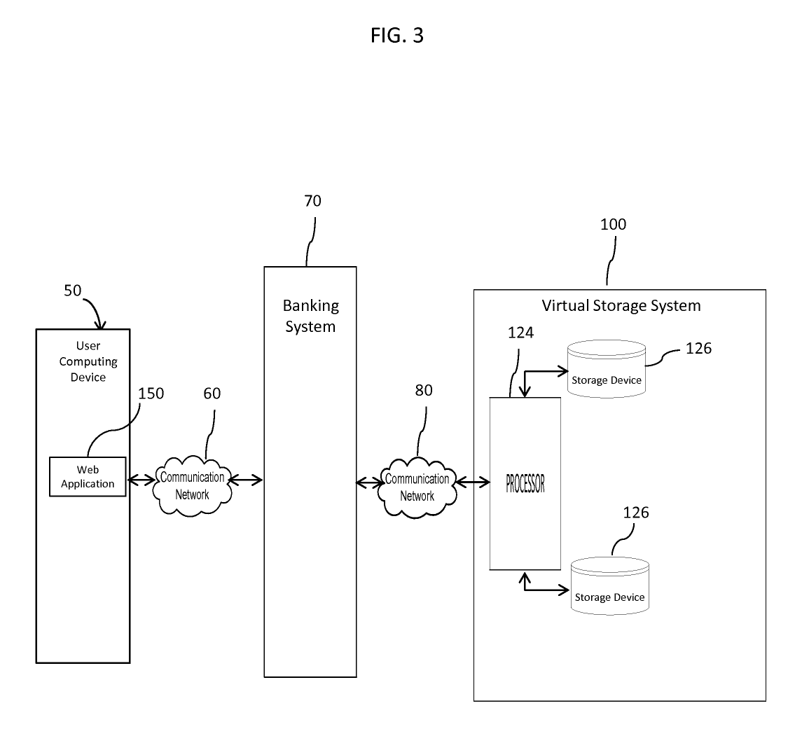

As shown in FIG. 3, in another alternative embodiment, the user computing device 50 includes a web application 150 (e.g., a web API) for connecting to the banking system 70 and the virtual storage system 100 indirectly through the banking system 70. The web application 150 is an internet-enabled application, for example, that has specific functionality for the user computing device 50 (e.g., a mobile phone). The web application 150 is accessed through a web browser of the user computing device 50 and does not require downloading and installing thereof onto the user computing device 50.

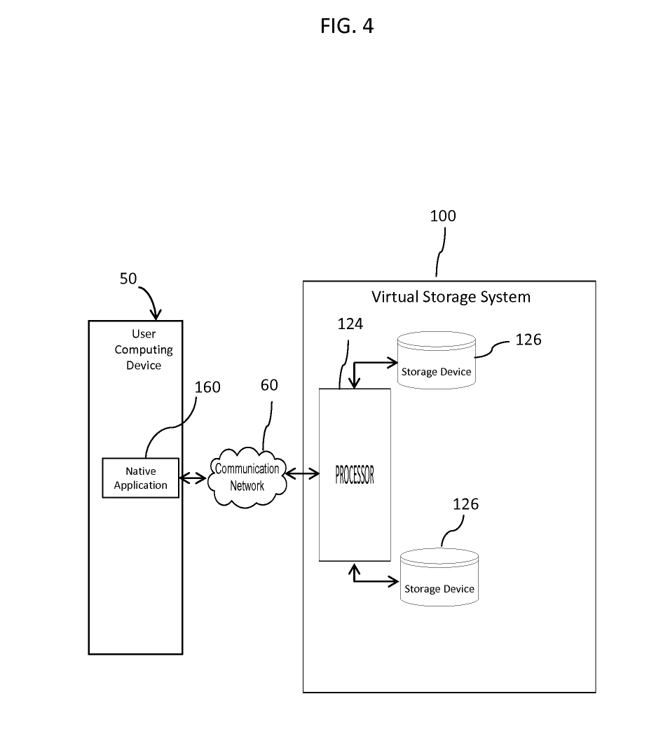

As shown in FIG. 4, in yet another alternative embodiment, the user computing device 50 includes a native application 160 for connecting directly to web services (i.e., the processor 124) of the virtual storage system 100. The native application 160 is directly installed on the user computing device 50 to allow the user to gain direct access to the virtual storage system 100. The native application 160 is a specifically-designed API for accessing the virtual storage system 100. For example, if the user computing device 50 is a tablet, the tablet may include a tablet API for directly accessing the web services of the virtual storage system 100. Therefore, in this embodiment, the web interface 130 of the banking system 70 as shown in the embodiment illustrated in FIG. 2; and the web interface 122 of the virtual storage system 100 as shown in FIG. 3 are omitted.

According to one or more embodiments, the native application 160 may include a multi-factor authentication process to be performed at many levels to enable a user to gain direct access to the virtual storage system 100 from the user computing device 50. The multi-factor authentication process may include steps such as sending login information (e.g., user ID and password information) in a correspondence (e.g., a text message or email) to the user, and providing a time-based one-time password system to the user via a third party.

According to another embodiment, a single-factor authentication process may be used to gain access to the virtual storage system 100 via the external system (e.g., the banking system 70) since the external system and the virtual storage system 100 communicate via a secure connection on the communication network 80.

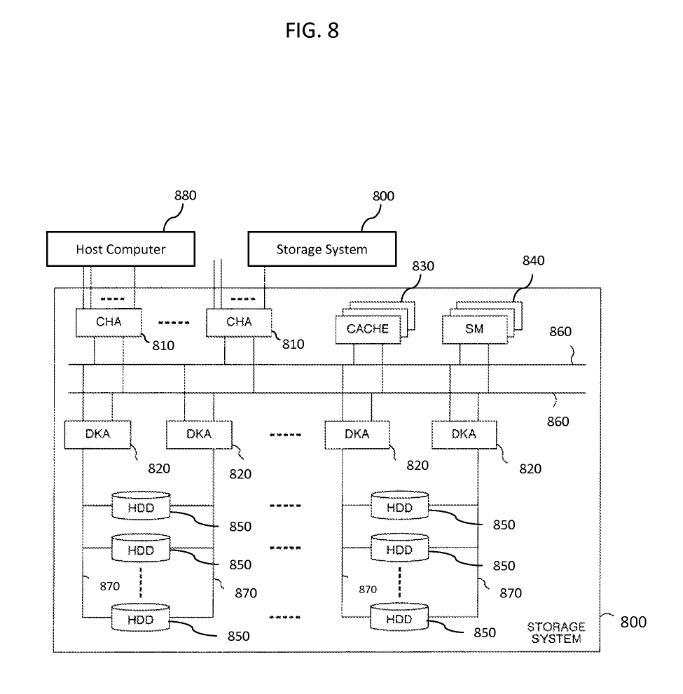

It should be noted that the virtual storage system is implemented on a physical storage system 800 such as that illustrated in FIG. 8.

As shown in FIG. 8, the physical storage system 800 includes a plurality of host adapters (CHA) 810, disk adapters (DKA) 820, cache memories (CACHE) 830, shared memories (SM) 840, and hard disk drives (HDD) 850 connected with each other via common paths 860 and connection lines 870. Each of the hard disk drives (HDD) 850 is connected to two disk adapters 820, for example, using different connection lines 870. The host adapters 810 control data transfer between host computers 880, the cache memories 830 and the hard disk drives 850. The cache memories 830 temporarily store data received from the host computer 880 and data read from the hard disk drives 850. The shared memories 840 are shared between the host adapters 810 and the disk adapters 820. The present invention is not limited to any particular number of host adapters 810, disk adapters 820, cache memories 830, shared memories 840 and hard disk drives 850, and may vary accordingly. The physical storage system 800 is one example of a physical storage system for which the virtual storage system can be implemented thereon. The present invention is not limited to a particular configuration of the physical storage system. According to other embodiments, the hard disk drives (HDD) 850 can be replaced with a flash storage, RAM disks or rotated disk drives, for example. The host computers 880 can be the processor 124 or a separate computer, for example. Further, the virtual storage system 100 can be implemented on any type of storage system such as a network-attached storage (NAS), a storage area network (SAN), or a distributed memory array.

According to one or more embodiments, the physical storage devices of the physical storage system 800 as described above can be configured in a RAID (Redundant Array of Independent Disks) configuration. Further, the reliability of the data stored in the storage devices 126 of the virtual storage system 100 can be stored in a redundant manner in redundant data centers using mirroring, remote copy, or the like. The use of redundant storage devices enables the data stored to be duplicated thereby preventing data loss.

When a user accesses the banking system 70 via a bank server, the user can be automatically directed to the virtual storage system 100 when desired.

As shown in FIGS. 1 through 4, the user computing device 50, banking system 70 and virtual storage system 100 can be connected with each other via the communication networks 60 and 80. According to one embodiment, the user computing device 50 may occasionally connect to the communication network 60 while the banking system 70 and the virtual storage system 100 may maintain a connection to the communication networks 60 and 80. Further, in FIG. 4 the user computing device 50 and the virtual storage system 100 are in direct communication with each other over the communication network 80.

According to alternative embodiments, the virtual storage system 100 can be included within the banking system 70 or the user computing device 50 as installable software.

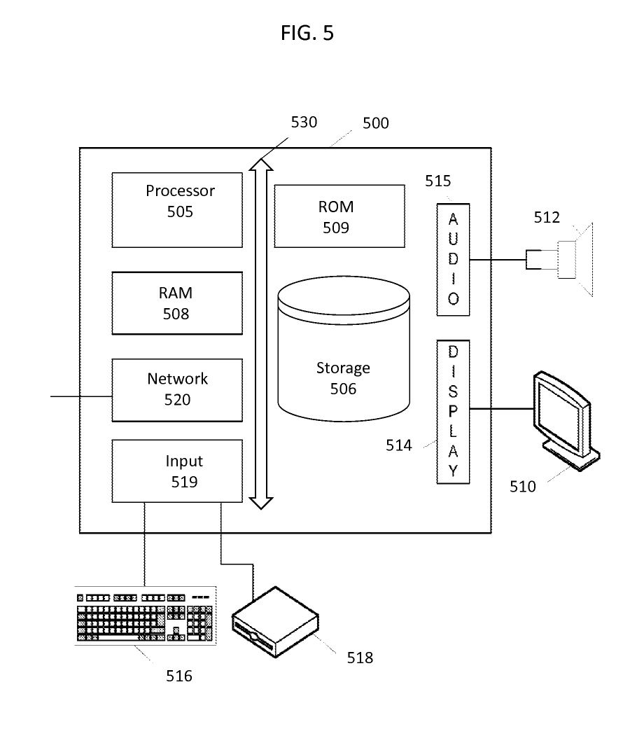

FIG. 5 is a block diagram of an exemplary computing device 500 illustrating components of the computing device 50, the banking system 70 and the virtual storage system 100 shown in FIG. 1. As shown in FIG. 5, the computing device 500 includes various components for inputting, outputting, storing and processing data. The computing device 500 includes a processor 505 for performing tasks including executing one or more applications, retrieving data from a storage device e.g., storage 506, and/or outputting data. The processor 505 can be connected to a Random access memory (RAM) module 508 wherein application data and/or instructions may be temporarily stored. The computing device 500 can further includes a Read Only Memory (ROM) 509 configured to allow data stored thereon to persist after the computing device 500 is turned off and is used for storing an operating system (OS) of the computing device 500. The storage device 506 may also provide storage for data files and may include computer readable mediums e.g., disk drives, optical storage mediums e.g., CD ROM drives, magnetic tape storage systems, and flash memory. The processor 505 is configured to retrieve an application from the storage 506 and store the instructions associated with the application in the RAM module 508, while the processor 505 is executing the application. The computing device 500 further includes output devices e.g., a display device 510, and a speaker 512, for outputting visual and audio data via a display adapter 514 and an audio adapter 515. Further, the computing device 500 includes input devices e.g., a keyboard 516, a storage media drive 518, and microphone each having an associated adapter 519 for converting the input data into computer readable data. The storage media drive 518 enables users to read and write data to and from the storage media.

Further, as shown in FIG. 5, the computing device 500 includes one or more components for receiving and transmitting data over the communication networks 60 and 80. For example, a network adapter 520 is provided for communication with one or more computing devices over an IP network, for example, for transmission of data such as financial data over a bank network. The network adapter 520 may include instructions associated with processing IP network packets and cellular network packets. The components of the computing device 500 are connected via a system bus 530.

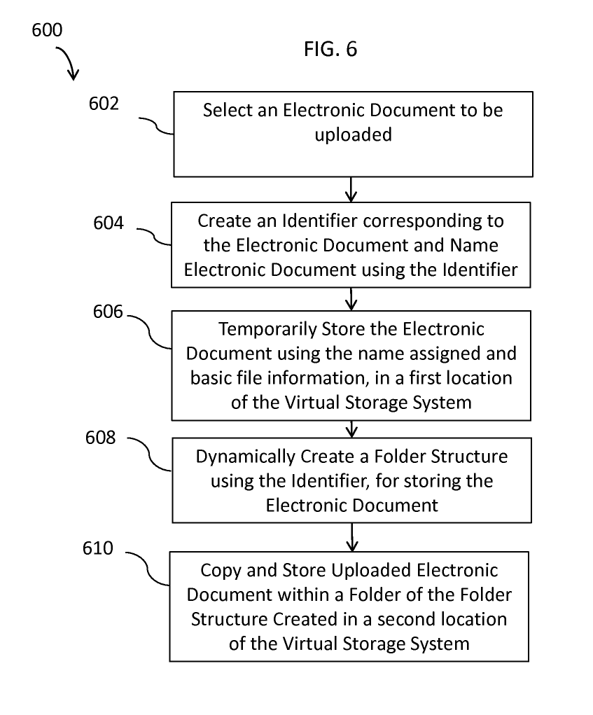

FIG. 6 is a flowchart illustrating a file storing method 600 according to one or more embodiments of the present invention. The method 600 is implemented in software modules for execution by the user computing device 50, the banking system 70 and the virtual storage system 100.

In method 600, an external system (e.g., the banking system 70) or the virtual storage system if accessed directly by the user, receives input data from the user at the user computing device 50 for requesting access to online account information (e.g., banking information) or a plurality of electronic folders within the virtual storage system 100. It is determined whether the user has access rights to the virtual storage system 100. In one or more embodiments, if the user is accessing the virtual storage system 100 indirectly through the banking system 70, access rights of the user may have been established by virtue of the user's access rights to the banking system 70. Thus, a verification process may be performed by the virtual storage system 100 at the banking system 70, via the secure connection over the communication network 80. Alternatively, if the user is accessing the virtual storage system 100 directly via the user computing device 50, access rights of the user may be verified by performing a multi-factor authentication process as discussed above.

At operation 602, an electronic document is selected from an external system by the user, to be uploaded to the virtual storage system 100. The user may also select an electronic folder of a plurality of electronic folders of the virtual storage system 100 as displayed to the user, for storing the electronic document upon uploading. From operation 602, the process continues to operation 604, where an identifier corresponding to the electronic document to be uploaded, is created and stored within the virtual storage system 100. According to one or more embodiments, the identifier is a globally unique identifier (GUID). A GUID is a unique reference number that is randomly generated. The GUID may be stored as a 128 bit values, for example, and represented as 32 hexadecimal digits grouped separated by hyphens such as “abcd0123-efg4-hij5-klm6-nopqrstuv789”, for example. In one or more embodiments, the identifier is used to name the electronic document being uploaded. The present invention is not limited to a particular naming structure, and any suitable naming structure may be implemented. The electronic document is named by the naming structure. According to one or more embodiments, the electronic document may be named according to a naming structure or name previously given within the external system, or a different naming structure created within the virtual storage system 100.

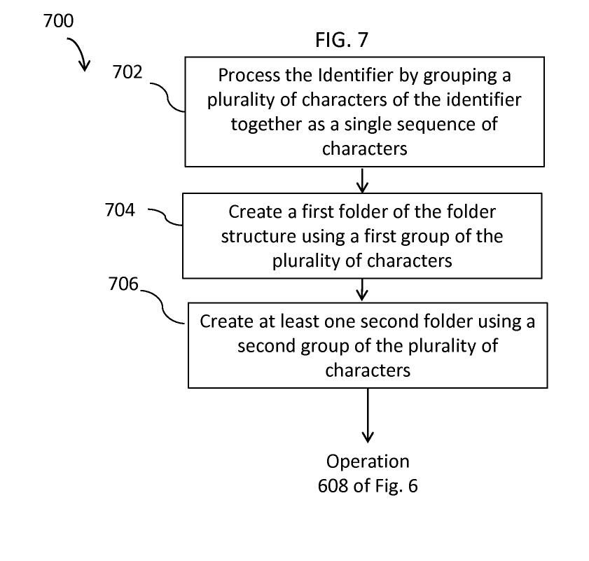

From operation 604, the process continues to operation 606, where the electronic document is temporarily stored using the name assigned and basic file information e.g., file size, in a first location within the redundant physical storage devices 126 of the virtual storage system 100. From operation 606, the process continues to operation 608, where a folder structure is dynamically created using the identifier for storing the electronic document. According to one or more embodiments, the electronic document is completely uploaded, named and temporarily stored, prior to creating a folder structure for permanently storing the electronic document. A detailed description of the folder structure creation operation is discussed below with reference to the flowchart in FIG. 7.

After creating the folder structure in operation 608, the process continues to operation 610 where the uploaded electronic document is copied and stored in a folder or subfolder of the folder structure in a second location (e.g., another storage device 126) of the virtual storage system 100.

FIG. 7 is a flowchart illustrating a folder structure creating operation 608 of the method of FIG. 6 implemented according to alternative embodiments of the present invention. In method 700, according to one or more embodiments, the identifier created and used to name the electronic document is also used to create the folder structure for storing the electronic document. The identifier is used to build a folder path for masking a storage location of the electronic document within the virtual storage system 100. Masking of the storage location provides added security protection of the electronic documents uploaded by a user.

At operation 702, the identifier is processed and a plurality of characters of the identifier are grouped together as a single sequence of characters, for example, “abcd0123efg4hij5klm6nopqrstuv789”.

From operation 702, the process continues to operation 704 where, the plurality of characters are divided into groups, for example, “abcd0123;” “efg4hi;” “j5klm6;” “nopqrs;” and “tuv789”. According to one or more embodiments, the groups include an equal number of characters. However, the present invention is not limited to any particular group structure of the plurality of characters of the identifier created.

From operation 704, the process continues to operation 706, where a first group of the plurality of characters is used to create a first folder of the folder structure, for example, “abcd0123.”

From operation 706, the process continues to operation 708, where at least one second group of the plurality of characters, for example, “efg4hi” is used to create at least one second folder of the folder structure. According to one or more embodiments, the first folder created may be a top level folder of the folder structure, and the at least one second folder may be a subfolder of the first folder. In one or more embodiments, more than one second folder may be created using the remaining characters of the plurality of characters. The folders may be organized in a hierarchy format where the first folder (e.g., “abcd0123”) includes a second folder (e.g., “efg4hi”) as a subfolder thereof, and the second folder (e.g., efg4hi) includes a third folder (e.g., “j5klm6”) as a subfolder thereof, for example. According to one or more embodiments, all of the plurality of characters of the identifier are used to create folders and subfolders of the folder structure.

The present invention is not limited to a particular folder creation process and may vary accordingly. For example, the folder structure may be created using user identification (ID) information and the electronic documents may be stored in a hierarchical manner within the virtual storage system 100.

According to one or more embodiments, an encryption process is performed on the electronic document prior to storing the electronic document within the folder structure. Further, the process continues to operation 610 of FIG. 6, where the electronic document uploaded is stored in one of the at least one second folders of the folder structure. The present invention is not limited to the electronic document being stored in a particular folder of the folder structure and may vary as desired. For example, one electronic document may be stored in a second folder of the folder structure, whereas another electronic document may be stored in a third folder of a respective folder structure.

The electronic documents are stored in the folder structures on the storage devices 126 of the virtual storage system 100.

Each electronic document is able to be viewed and accessed from an electronic folder of the plurality of electronic folders within the virtual storage system 100, where the electronic document is stored.

The electronic document is accessible only by the user at the user computing device 50 via the banking system 70 according to one embodiment, or via the virtual storage system 100 directly according to alternative embodiments.

The electronic document upload, encryption, identifier creating and folder structure creating operations are performed via the processor 124 of the virtual storage system 100. According to one or more embodiments, the folder structure creation may be performed in one storage location of the virtual storage system 100 (e.g., a first data center), and the uploading operation of the electronic document may be performed in another storage location (e.g., a second data center) of the virtual storage system 100.

The present invention is described herein in terms of block components, screen shots, and optional selections and processing steps. It should be appreciated that the functional blocks may be realized by any number of hardware and/or software components configured to perform the specified functions. For example, the present invention may employ various integrated circuits e.g., memory elements, processing elements, logic elements, look-up tables, and others which may perform the functions under the control of one or more processors or other control devices. The software components can be implemented with any programming or scripting language, with various algorithms implemented with data structures, objects, processes, and other programming elements.

In view of the above, the present method embodiment may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the invention. This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

According to one or more embodiments, a virtual storage system in data communication with a user computing device via a communication network is provided. The virtual storage system comprising at least one processor configured to: receive a selection of an electronic document to be uploaded from an external system, create an identifier corresponding to the electronic document, and create a folder structure using the identifier, for storing the electronic document; and a plurality of redundant physical storage devices in data communication with the at least one processor and each configured to store the electronic document within a folder of the folder structure created.

According to one or more embodiments, a method implemented by computer system to effect the storing of electronic documents within a virtual storage system including a plurality of redundant physical storage devices and in data communication via a communication network, with an external system is provided. The method comprising receiving input data for accessing the virtual storage system directly or indirectly via the external system; selecting via a user, an electronic document to be uploaded from the external system; creating an identifier corresponding to the electronic document; and creating a folder structure using the identifier, for storing the electronic document; and storing the electronic document within a folder of the folder structure created within the plurality of redundant physical storage devices.

According to one or more embodiments, a computer readable medium storing computer executable instructions that, when executed, cause a computing device to perform a file storing method for storing electronic documents within a virtual storage system including a plurality of redundant physical storage devices and in data communication via a communication network, with an external system is provided. The method comprising receiving input data for accessing the virtual storage system directly or indirectly via the external system; selecting via a user, an electronic document to be uploaded from the external system; creating an identifier corresponding to the electronic document; creating a folder structure using the identifier, for storing the electronic document; and storing the electronic document within a folder of the folder structure created within the plurality of redundant physical storage devices.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A virtual storage system in data communication with a user computing device via a communication network, the virtual storage system comprising:
at least one processor configured to:
receive a selection of an electronic document to be uploaded from an external system,
create an identifier corresponding to the electronic document, and
create a folder structure using the identifier, for storing the electronic document; and
a plurality of redundant physical storage devices in data communication with the at least one processor and each configured to store the electronic document within a folder of the folder structure created.

2. The virtual storage system of claim 1, further comprising:
a web interface configured to interface the virtual storage system with the external system and the user computing device, via at least one communication network.

3. The virtual storage system of claim 1, wherein the external system comprises a web interface configured to interface the external system with the virtual storage system.

4. The virtual storage system of claim 1, wherein the user computing device comprises a web application configured to interface the user computing device with the virtual storage system, via the external system.

5. The virtual storage system of claim 1, wherein the user computing device comprises a native application configured to interface the user computing device directly with the virtual storage system.

6. The virtual storage system of claim 1, wherein the external system is an online document retrieval and storage system.

7. The virtual storage system of claim 6, wherein the online document retrieval and storage system is a banking system and the electronic document is a bank statement.

8. The virtual storage system of claim 1, wherein the identifier is a globally unique identifier (GUID).

9. The virtual storage system of claim 1, wherein the identifier is used to name the electronic document to be uploaded.

10. The virtual storage system of claim 1, wherein the identifier comprises a plurality of characters to be divided into a plurality of groups, wherein a first group of the plurality of characters forms a first folder of the folder structure, and a second group of the plurality of characters forms at least one second folder of the folder structure.

11. The virtual storage system of claim 10, wherein the at least one second folder is a subfolder of the first folder.

12. A method implemented by computer system to effect the storing of electronic documents within a virtual storage system including a plurality of redundant physical storage devices and in data communication via a communication network, with an external system, the method comprising:
receiving input data for accessing the virtual storage system directly or indirectly via the external system;
selecting via a user, an electronic document to be uploaded from the external system;
creating an identifier corresponding to the electronic document; and
creating a folder structure using the identifier, for storing the electronic document; and
storing the electronic document within a folder of the folder structure created within the plurality of redundant physical storage devices.

13. The method of claim 12, wherein the identifier is a globally unique identifier (GUID).

14. The method of claim 12, wherein the identifier is used to name the electronic document to be uploaded and to temporarily store the electronic document within a first location of the virtual storage system, and
wherein the electronic document is permanently stored in the folder of the folder structure within a second location of the virtual storage system.

15. The method of claim 12, further comprising:
processing the identifier and grouping a plurality of characters of the identifier together as a single sequence of characters;
dividing the single sequence of characters into a plurality of groups;
creating a first folder using a first group of the plurality of characters;
creating at least one second folder using at least one second group of the plurality of characters.

16. The method of claim 15, wherein the at least one second folder is a subfolder of the first folder.

17. A computer readable medium storing computer executable instructions that, when executed, cause a computing device to perform a file storing method for storing electronic documents within a virtual storage system including a plurality of redundant physical storage devices and in data communication via a communication network, with an external system, the method comprising: receiving input data for accessing the virtual storage system directly or indirectly via the external system;
selecting via a user, an electronic document to be uploaded from the external system;
creating an identifier corresponding to the electronic document;
creating a folder structure using the identifier, for storing the electronic document; and
storing the electronic document within a folder of the folder structure created within the plurality of redundant physical storage devices.

18. The computer readable medium of claim 17, wherein the identifier is a globally unique identifier (GUID).

19. The computer readable medium of claim 17, wherein the identifier is used to name the electronic document to be uploaded and to temporarily store the electronic document within a first location of the virtual storage system, and
wherein the electronic document is permanently stored in the folder of the folder structure within a second location of the virtual storage system.

20. The computer readable medium of claim 17, wherein the method further comprises:
processing the identifier and grouping a plurality of characters of the identifier together as a single sequence of characters;
dividing the single sequence of characters into a plurality of groups;
creating a first folder using a first group of the plurality of characters;
creating at least one second folder using at least one second group of the plurality of characters.
